(19) United States
(12) Patent Application Publication
(10) Pub. No.: US 2007/0156559 A1
(43) Pub. Date: Jul. 5, 2007

(54) Financial Planning System

(76) Inventors: Bernard H. Wolzenski, St. Louis, MO (US); Jack J. Desemar JR., Baton Rouge, LA (US); Charles E. Afeman, Baton Rouge, LA (US)

Correspondence Address: ROBERT C. KAIN, JR., 750 SOUTHEAST THIRD AVENUE, SUITE 100, FT LAUDERDALE, FL, 333161153, US

(21) Appl. No.: 11/686,109

(22) Filed: Mar. 14, 2007

Related U.S. Application Data
(63) Continuation-in-part of application No. 09/717,189, filed on Nov. 21, 2000.
(60) Provisional application No. 60/167,083, filed on Nov. 23, 1999.
(60) Provisional application No. 60/782,079, filed on Mar. 14, 2006.

(51) Int. Cl. G06Q 40/00

(52) U.S. Cl. 705/35

(57) ABSTRACT

The financial planning tool is software defining a data structure which generates a financial-estate plan using liquidity analysis of a comprehensive list of client assets (categories I-IV, personal, reserve capital, unprotected retirement, and protected retirement assets). The system obtains asset net equity before and after tax and calculates life annual income based on a financial formula with modifiable variables. Current estate tax values and liquidity at-death values for estate conditions (client and spousal death, spousal survival and client survival). Post-death annual income is calculated. Comparing unprotected and protected life annual income for asset categories I-III vs. IV with goals, identified surpluses and deficiencies result in transfer or liquidation-repurchase of assets between categories. Conventional life insurance is either purchased or cancelled or a daily rated, minimum at risk death premium life insurance product is purchased.

This is a continuation-in-part of U.S. patent application Ser. No. 09/717,189, filed Nov. 21, 2000, now pending, which was a regular patent application based upon provisional patent application Ser. No. 60/167,084, filed Nov. 23, 1999, and the present application is a regular patent application based upon provisional patent application Ser. No. 60/782,079, filed Mar. 14, 2006, now pending, the content of these filings being incorporated herein by reference thereto.

The present invention relates to a financial planning system and program which generates a financial and estate plan using liquidity analysis of client assets and using purpose-based categorization of those assets. The invention, generally referred to herein as the “Future System,” consists of Future System Planning Strategies, a Future System Life Insurance Product Model, and a Financial Asset Categorization Tool (“FACT”).

### BACKGROUND

Currently, there is no a comprehensive financial methodology that ties together solutions for many of the core issues related to a client's wealth management. Planning gaps and issues are present in most financial plans and the plans lack any meaningful correlation to or function with a client's lifestyle.

Specifically, there was no financial planning system that defines or encompasses all the core issues facing a client, distinct from peripheral issues. There are many issues that can be discussed with a client to prepare a comprehensive financial plan. This is why even the most comprehensive planning systems that attempt to cover all the issues still leave gaps in planning. The inventors realized that it was necessary to redefine the core issues such that the plan would leave no gaps if these core issues were solved or answered and if the solutions to the core issues properly interact with each other. The definition of “core issues” required some overlap to avoid gaps, and yet enough distinction to be defined as core issues. The number of core issues had to be reduced to their elemental level and still be meaningful in supporting the client's goals. The order in which the core issues should be addressed was a concern. The inventors noticed in existing financial planning systems that focusing on a single issue and solving that issue would change the data set for other issues. Prior art plans lacked a mechanism to interrelate each of the core issues to the client's lifestyle. This forced the client to go back and resolve previously solved issues. Of course, this redesign would change the data set and require re-assessment of other issues in the wealth management plan. The inventors realized the impossibility of this methodology and the need for a process that would solve all the core issues simultaneously; or a single strategy that could be used for each core issue that all financial management disciplines could accept. Professionals from each financial management discipline (e.g. investment, finance, accounting, law, tax, insurance, etc.) have a different strategy for each issue based on their training, education, experience and expertise. It was not that one was right and another was wrong, but that each was different. Existing financial planning techniques are difficult for many clients to understand. Advisors from different disciplines could not understand these techniques, nor agree with and accept these prior art techniques. Further, no plan addresses how each of the client's assets interact with a singular plan to define a solution for each strategy. Focusing on a single issue and applying a single set of assets to that issue's solution is extremely inefficient, ineffective, and costly. The inventors discovered how to make assets do double or triple duty; and furthermore, once a planning methodology was developed to address all the core issues successfully, there was no life insurance product that could work within the rule sets of the new planning methodology.

The present methodology was not adequate to prepare a comprehensive wealth management plan because the clients and the inventors were not satisfied with existing methods.

### OBJECTS OF THE INVENTION

It is an object of the present invention to provide a comprehensive financial management plan for wealth management of client assets.

It is another object of the present invention to provide planning software which is deployed on the Internet.

It is a further object of the present invention to provide planning software that groups client assets by function with the goal to achieve a client-centric liquidity analysis during the client's productive lifetime, during retirement, in the event of the client or client spouse's' death, and in light of tax and inheritance considerations.

It is an additional object of the present invention to provide planning software that can be used by the client's advisor to explain the grouping of assets by function or purpose (a client-centric formulation) and permit the client to re-allocate his or her assets to achieve a better balance between lifestyle-linked assets, reserve capital assets, unprotected retirement assets, and protected retirement assets.

### SUMMARY

The comprehensive financial management planning tool is a software program deployed on a personal computer PC or laptop or a computing device linked to a server via the Internet or other telecommunications network. The computerized process generates a financial and an estate plan using liquidity analysis of a comprehensive list of client assets. These assets include client owned or controlled personal assets and pleasure assets, homes, boats, automobiles, jewelry, planes (category I assets), reserve capital assets such as cash and cash equivalents such as checking, savings, money market accounts, certificates of deposit, treasury bills, earned income, passive investment ordinary income distributions, passive investment ordinary income dividends (category II assets), unprotected retirement funding assets such as securities managed tax efficiently, tax-free income producing securities, sheltered income producing securities, qualified dividend stocks, individual stocks that are held long term, municipal bonds, municipal bonds funds, equity in closely held companies, investment real estate (category III assets), tax deferred financial products such as annuities, qualified retirement plans, non-qualified retirement plans, IRA's, simplified employee pensions (SEP's) and life insurance (category IV assets), and assets subject to a gifting or charitable giving plan (category V assets). The planning program organizes the client asset financial data in a data structure for each of the four categories.

The system obtains, for each asset, a net equity before tax value data and a net equity after tax value data and stores the values in the data structure. The system planner then calculates for each asset a life annual income based on a financial payment formula including client modifiable variables such as interest rate, life expectancy, amount of principal to retain (retained principal per client instruction), and an inflation variable. The formula has a life annual income payout value which is indexed for inflation. Current estate tax values for each asset and current liquidity at-death values for each estate condition are also obtained and stored. The “estate condition” is one condition from the group of estate conditions consisting of death of both said client and a client spouse, death of client and survival of client spouse, and death of a client spouse and survival of said client. The planning software calculates a post-death annual income for each estate condition reflecting income after taxes. This data is stored in the data structure.

The system combines life annual incomes for all assets in categories I, II and III (projected, combined life annual income) and combines life annual incomes for all assets in category IV to obtain a projected, protected combined life annual income.

The system also obtains a client life annual income goal and a client protected life annual income goal wherein the “protected life annual income goal” is a minimum amount acceptable to said client if all assets in asset categories I, II and III were involuntarily transferred or taken away due to bankruptcy or lawsuits. Surpluses and deficiencies are identified between projected, combined life annual income, the life annual income goal, and the projected, protected combined life annual income and the protected life annual income goal. The projected combined capital to account for surpluses and deficiencies is calculated and all this data is stored in the planning system such that, upon command, the data structure, and all the related processed financial data can be displayed. Surplus between projected life annual income and life annual income goal results in a transfer of assets from categories I, II and III to category IV which may involve liquidation and re-purchase of assets. A deficiency requires transferring assets or liquidating or revising the client's life annual income goal and client's protected life annual income goal and re-calculating surpluses and deficiencies. Substantially the same process operates on the post-death annual incomes for all estate conditions and uses combined post-death annual incomes for all assets, and projected, protected combined post-death annual income data including life insurance proceeds. Surpluses and deficiencies are identified and assets are transferred or liquidated and re-purchased and life insurance is either purchased or cancelled or Future System life insurance product is purchased.

### BRIEF DESCRIPTION OF THE DRAWINGS

Further objects and advantages of the present invention are discussed later herein in conjunction with the accompanying drawings in which:

FIG. 1A illustrates Table 1 which is used to explain the financial planning system and process.

FIG. 1B graphically illustrates insurance payments with previous financial planning systems and processes.

FIG. 2 graphically illustrates insurance payments with the present financial planning system and process.

FIGS. 3-13 illustrate Tables 3-13 which explain the financial planning system and process.

FIG. 14 diagrammatically illustrates a simplified computer system over which is deployed the financial planning system and process.

FIG. 15 diagrammatically illustrates a simplified computer process with the financial planning system.

FIG. 16 diagrammatically illustrates another computer system over which is deployed the financial planning system and process.

### DETAILED DESCRIPTION

The present invention relates to a financial planning system and program which generates a financial and estate plan using liquidity analysis of client assets and using purpose-based categorization of those assets. The planning system and unique life insurance product (Future System Life Insurance) is initially discussed herein. Thereafter, aspects of the computer system are discussed.

The Future System Planning Strategies consist of educational tools and processes that enable clients to understand a holistic approach to the efficient use of all of their financial assets. This “holistic approach” encompasses support for the client's lifestyle, liquidity needs, retirement needs, asset protection needs, and estate or legacy goals. These needs and goals are best met if a new form of life insurance, the Future System Life Model or Life Insurance Product, is available. The Future System Life Insurance Product Model embodies new actuarial processes that are specified in and arise from the Future System. FACT, the financial planning software, brings together the client data, the Planning Strategies, and the Life Insurance Product Model to provide a unique individualized solution for each client.

Previously, there was no financial planning system that defined all the core issues distinct from peripheral issues. There was no financial planning system that defined how the core issues interact with each other. The inventors started with Maslow's hierarchy, flipping it upside down, and correlating it to a financial structure. This led the inventors to a finding that there were five core issues or areas of planning critical to a wide range of clients seeking wealth management advice. The inventors currently identify these issues as “categories,” which are defined below.

There was no financial planning system that defined an order in which the core issues should be addressed. There is no single order or sequence of operations that worked for a wide range of financial plans for clients. The only workable solution is one that solves all core issues simultaneously.

There was no financial planning system that defined a single strategy that should be used for each core issue that all disciplines could accept. The inventors extracted the best parts of each professional's strategy and employed those parts in a single, unified strategy and used that strategy as a starting point to develop a new, overall strategy for the Future System methodology. The result was a single set of strategies that work together seamlessly. These new strategies are different than existing strategies, because they were based on Future System rule sets that did not previously exist.

There is no financial planning system that defines how each of a client's assets interacts to define a solution for each strategy. The inventors use the “purpose” of each asset in relation to the client's life or the asset's function to the client's lifestyle as the primary factor to determine the placement of each asset into the proper category. The inventors then defined certain functional values that are key to each asset. The result is a planning system and a process which simultaneously uses all assets to solve each issue, instead of specific assets to solve specific issues.

Once the planning methodology was developed to address all the core issues successfully, there was no life insurance product that could work within the rule sets of the new planning methodology. The inventors developed a set of specifications within the current tax and insurance laws, rules and regulations that follows the Future System rule set as to how a life insurance product should be designed, managed, and perform. This model represented a life insurance product that did not exist, which became the Future System Life Insurance Product Model.

The Future System planning software and the Future System Life Insurance Product Model solve the following problems. Each individual is unique. The Planning System provides a unique set of planning tools which address needs faced by most clients. With this in mind, the inventors reviewed different issues that a financial advisor might discuss with a client. These issues were condensed into a small core group that addresses major concerns of most clients. Other client questions and concerns are considered peripheral planning issues. Development of the unique planning system started with Maslow's hierarchy. The inventors flipped it upside down and correlated it to a financial structure. Within this new structure, the inventors identified five main categories: Stuff, Cash, Spend, Save, and Give. The inventors then assigned specific asset types for each Category. Proper Category funding requires that assets should not only be of the right type for the Category but also be the right amount or value. From experience, the inventors knew that if all asset types within these 5 categories interact in a certain way, there would be no gaps in a person's financial planning. The planning approach involves categorizing each asset on a client's financial statement into these categories (the Categories being a data structure for the planning software) and assigning functional values for each asset such as market value, growth, liquidity value, income, and taxation.

The overriding factor that determines an asset's category is that asset's function to the client's lifestyle and its purpose in the client's life. Determining the correct amount for different asset types in each Category helps the client move towards a goal of achieving a “Balanced” financial plan. “Balance” is achieved when each Category is fully funded according to the client's personal wishes. With this background, the inventors were able to determine the use, structure, and appropriate amount of the Future System Life Model Insurance Product which fulfills liquidity, asset protection from bankruptcy, and traditional life insurance purposes.

Category 1—Personal and Pleasure

The first category is the client's stuff. It's important to have stuff. It's what the client owns for personal and pleasure purposes. It's the client's home, autos, jewelry, boat, car, plane, and vacation home. The purposes of stuff are shelter, enjoyment and to enhance lifestyle. It doesn't matter if it produces income. It doesn't matter if it grows. It doesn't matter about its rate of return. It doesn't even matter if the client pays too much for certain stuff if the client really wants it and it fits the client's lifestyle goals, and the client is in balance in the other categories. The system recognizes that specific assets from all categories create a fund for estate liquidity purposes when the client dies, when or his/her spouse dies and when both die. The key is to not have too much or too little stuff in relation to the other asset categories and to be in “Balance.” Category 1 assets are mostly non-exempt assets. By “non-exempt” it is meant that a court could force the liquidation of a given asset to satisfy a debt. Different jurisdictions may have somewhat different criteria for determining if an asset is exempt or non-exempt.

Category 2—Reserve Capital

Category 2 is the client's cash. It's the client's reserve capital. These types of assets are cash and cash equivalents such as checking, savings, money market, T-bills, and CDs. The purposes of reserve cash are emergencies, opportunities, capital expenditures, operating capital and estate liquidity (i.e. cash readily available from a person's estate upon the death of said person). It's critical to have the right amount of cash. A young surgeon making two million a year might only need one hundred thousand of operating capital because of his cash flow whereas a real estate developer or a contractor might need five million. So it's different for everybody and the key is to have the right amount. Like Category 1 assets, it also doesn't make any difference if the client's cash is getting the maximum rate of return that the client could possibly get somewhere else because that's not its function in the client's life.

Category 3: Retirement Funding

Category 3 is the client's spend category. The inventors defined client stuff, client cash, and client spend categories. The types of assets in Category 3 all have one characteristic in common: the assets are tax efficient. In Future System terminology, that means that the client can control the timing and rate of taxation at or below the tax rate for long-term capital gains. Examples of the types of assets in this Category 3 are securities managed tax efficiently, tax-free or sheltered income producing securities such as qualified dividend stocks, munis (i.e. municipal bonds), closely held companies, and investment real estate. This is the Category that will be the primary income source to be liquidated and consumed at the client's retirement, whether the retirement is voluntary or forced by disability or illness. Assets in Category 3 are generally non-exempt and also provide estate liquidity. With Category 3, the inventors began to see some real differences compared to traditional financial planning. Category 3 is unique because it doesn't include any assets that people normally think of and use for retirement income: like retirement plans, annuities and life insurance. The inventors place those assets in Category 4.

Category 4: Estate Protection

Category 4 the client's Save category. The inventors' system defines client stuff, client cash, client spend, and client save Categories. Asset types in Category 4 have one thing in common: they are tax inefficient as opposed to Category 3 assets which are tax efficient. “Tax inefficient” in Future System terminology means that the client will pay ordinary income tax rates when the client liquidates one of these assets and the client cannot always control the timing and distributions of realized capital gains. Examples of asset types in Category 4 include corporate bonds, tax unqualified dividend securities such as REITS (Real Estate Investment Trusts), mutual funds that are tax inefficient by nature, and securities managed without tax consideration such as short term trading. These asset types are non-exempt and tax inefficient. When the assets are placed inside of the following vehicles: Future System Life Insurance Product Model or insurance product, annuities, SEPs (Simplified Employee Pension), IRAs (Individual Retirement Account), qualified plans, non-qualified plans, or traditional life insurance, the assets become either tax free or tax deferred and mostly exempt in a bankruptcy liquidation. In this sense, the assets in Category 4 are “protected” from the client's creditors. By “qualified” it is meant that a given savings plan qualifies for tax deferred treatment. Contributions to qualified plan, for example, can be tax deductible. Tax is paid on said contributions and any income earned on said contributions when said deposits are withdrawn. Qualified plans are not necessarily tax efficient plans since withdrawals are taxed at the rate of ordinary income (e.g. 40%) as opposed to capital gains (e.g. 15%).

Category 4 has four primary purposes. The first purpose is to provide a secondary source of retirement income just in case the client spends everything in Category 3. The second purpose is to provide a security blanket from creditors just in case of the unlikely event that the client gets sued and loses everything in Categories 1, 2 and 3. This is what the client has to start over again. Category 4 assets are typically not available to plaintiffs in the event of a lawsuit since the assets are exempt. The assets are therefore “protected.” The third and one of the most important purposes of Category 4 is to leave assets to heirs or to charity at death in the most tax and financially efficient way possible. Category 4 assets also provide estate liquidity.

Category 5: Outside the Estate

Category Five is the client's Give Category. These client assets are marked by the client to be given away while he or she is alive, either to heirs or charity. These assets can be anything as per the client's instructions. It's not based strictly on tax as many planning strategies allude. The basis for deciding which assets to gift away can be availability, desire, control, emotion, financial tax ramifications but without commitments to future amounts. The primary purposes of this Category 5 are reduction of future income and estate taxes, current enjoyment of heirs, charitable intent, and to also provide estate liquidity.

Future Planning System's Financial Design Strategies

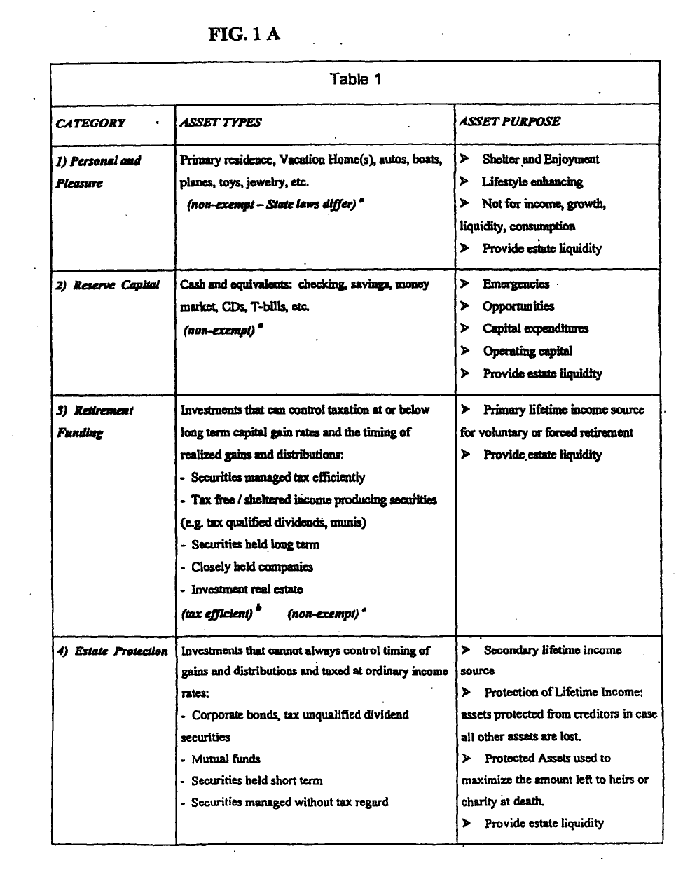

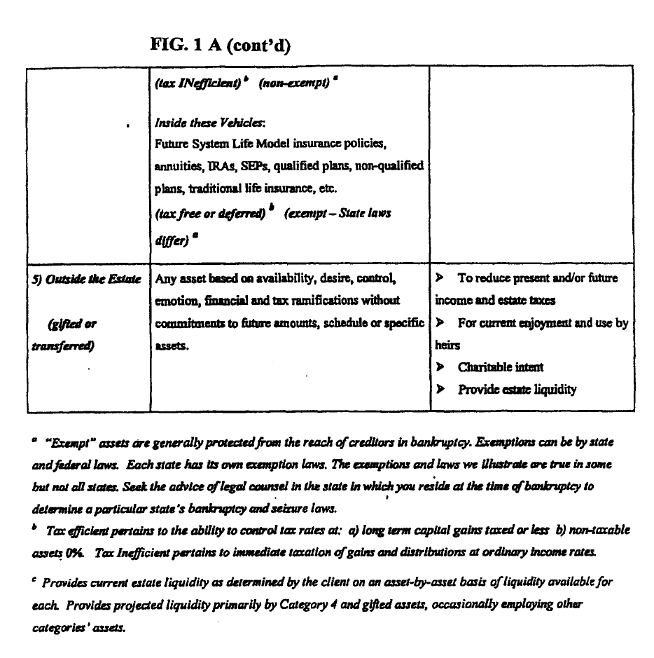

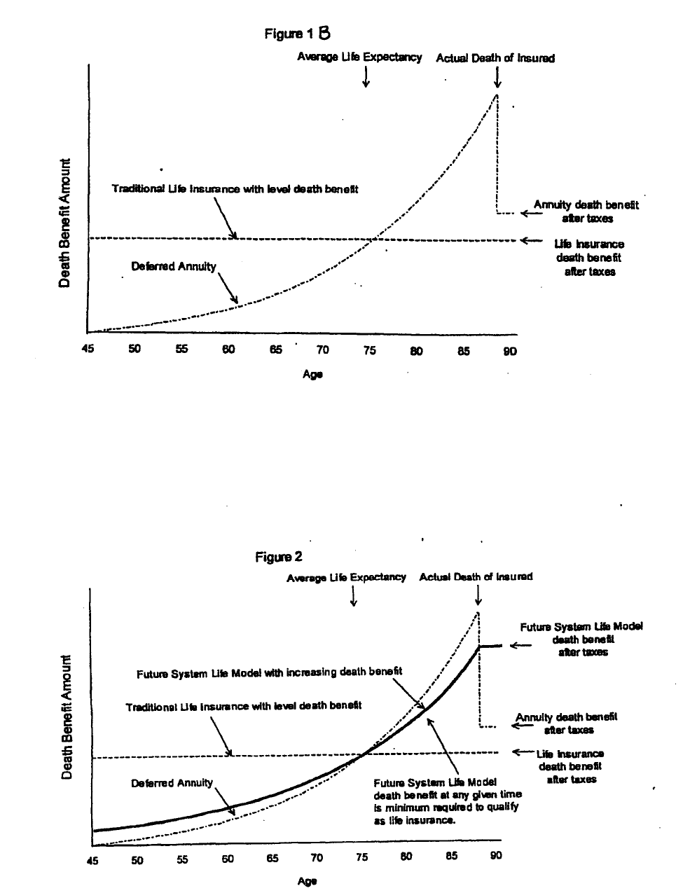

Table 1 (FIG. 1A) is a summary table of all of the categories at a glance, Stuff, Cash, Spend, Save, and Give. Please note that this Table 1 is a completely tax efficient model for a tax efficient life, by design not by accident. Also, please note that if the client's asset mix was “in balance,” all of the client's core needs and problems would be addressed and taken care of. “Balance” means that a person has all the stuff and reserve capital they need and want, they have enough in Categories 3 and 4 to fund retirement for life, enough in Category 4 to provide the security blanket, and have gifted or are gifting the desired amount into Category 5.

The first step in the Future System planning process is to make transfers between Categories and between Category Asset Types. While building the estate with surplus income, all 5 Categories should be funded in proportion to each Category's long-term goals. These goals are input into the data structure by the client or his or her advisor.

To build Category 4, the protected asset category, the inventors recommend first maximizing qualified retirement plans to the level of contributions desired for all participants. For example, if a person owns a business that has employees, a qualified plan for said person may have to include added costs for contributions for said employees. The person, however, may not want to incur said added costs. In this case, the business owner may conclude to not make any contributions to a qualified plan, including for himself.

The IRA (Individual Retirement Account) went from maybe being the worst asset the client could possibly own to transfer money to heirs to probably the best when the “stretch” IRA rules were issued by the IRS. Now the client can go two, three, four, five generations and still have money remaining in a tax-deferred account. This is the best reason of all to change the client's qualified plans to IRAs when the client retires. But the amount of money the client can put in IRA's or qualified plans is very limited. Before development of the Future System Life Insurance Product Model insurance product, the only alternatives for funding Category 4 were annuities and traditional life insurance. Annuities have the “tax trap” at death and traditional life insurance is extremely inefficient for accumulation because of the cost of“at risk death benefit”. This detriment is discussed in detail below.

The Future System Life Insurance Product Model functions as a Category 4 asset specifically for transfers from other categories in the amounts over and above what is put into qualified plans and IRAs. The inventors also use the Future System Life Insurance Product Model to accept transfers from other Category 4 assets such as traditional life insurance, annuities not projected to be consumed and required minimum distributions from qualified plans and IRAs.

After all Categories are in “Balance” and fully funded, the remaining surplus assets have no defined purpose. These assets can be placed into Category 4 for heirs or charity in the most tax efficient and financially efficient way possible. As a by-product, the use of Category 4 to shield assets provides an increased level of security during life of the client. The Future System Life Insurance Product Model is also a great vehicle to use for gifts into Category 5, which then becomes a Category 4 asset for the heirs in building their estate categories.

New order for consumption of assets to provide retirement income.

Traditional financial planning strategies use qualified plans, IRAs, annuities, non-qualified plans, and even traditional life insurance for retirement income. The Future System provides an unusual order of consumption of assets at retirement. The first assets consumed at retirement are any surplus Category 2 assets and all Category 3 assets except specific assets, such as a family business, that the client wishes to leave intact to heirs. If these assets are insufficient, then the client begins consuming qualified plan assets, annuities, and IRAs. If the client depletes these assets and is still alive, then and only then are the Future System Life Model products consumed.

There are two reasons for this unusual order of consumption. The first is that it is unwise for a client to consume his or her security blanket (Category 4) assets first. If clients did so, they could lose everything if they were sued later. Instead, the Future System strategies have them keep their exempt or protected assets in reserve, and spend their unprotected assets first.

The second reason is taxation. It is much more tax efficient to consume Category 3 assets first. That is because when a client liquidates a Category 3 asset, he or she pays between 0% and 15% to consume either the principle or long-term capital gains. However, when a Category 4 asset is liquidated, a client pays ordinary income or short-term capital gain rates of as much as 40%.

Future System Life Insurance Product Model and Death Benefits of Various Types of Life Insurance

During the development of the Future System Life Insurance Product Model, the inventors graphed the death benefits of all the different types of life insurance and annuity policies that were then available. FIG. 1B is a graph showing the range of life insurance and annuity policies. This graph represents the full spectrum of policies if one assumes the same pricing and the same premium for each. Dashed and dot-dashed lines are shown for Traditional Life Insurance and Deferred Annuity respectively in FIG. 1B. Each policy is purchased when the insured (the client) is 45 years old. In this example, the insured lives a longer than expected life. The life expectancy of the insured is 75 at the time they purchase the insurance. The insured lives to 90, however, a longer than expected life. This graph shows actuarial theory in this example, not specific policies. As you can see, the client starts out with a drastically different amounts of death benefit. Assuming the client is putting $10,000 a year into each one, the deferred annuity could start with a death benefit on day one of only $10,000 whereas the Traditional Life Insurance could be $1 million. So if the client dies on day one, there is a drastic difference as to how much money the beneficiary of the client's life insurance receives. At a later time, the curves cross over at expected mortality (e.g. age 75) and then invert. The deferred annuity ends up with the most death benefit and the traditional life insurance policy ends up with the least. The decrease in the death benefit of the deferred annuity upon death of the insured—client represents the ordinary income tax on the entire gain of the annuity at death, even if it's left to the surviving spouse. This is an IRD tax (or Income in Respect of a Decedent). An annuity is one of very few non-qualified assets that does not get a step-up in basis at death so that there is no income tax. Even the client's shoes would get a step-up in basis if the shoes were sold at a gain after death so that there would be no income tax. Once the client has a deferred annuity, it's a giant tax trap for heirs for which there is absolutely no way around. During product development, based upon this graph, the inventors wanted to find out what made the annuity perform so well in the long run. The only difference in any of these products is the amount of at-risk death benefit and the money being paid for the resulting COIs (Cost Of Insurance). The money not withdrawn from the policy to pay for COIs is compounding internally in the cash value of the policy, and over time enables the death benefit of the annuity to catch up and surpass the death benefit of the life policies, proving that the client can do better with his or her money than buying life insurance if the client lives long enough. Cumulative COI cost can be much more than the death benefit itself if the client lives long enough (interest adjusted).

COIs in any one year do not seem like a lot of money, but over a lifetime, the client can pay much more than a dollar for every dollar of “at risk” death benefit in a given policy, making the cost of insurance charges the single largest policy cost. This is how an insurance company operates. In theory all these 45 year olds are putting the same amount of money into the pot every year and get back the same amount of death benefit at death. The insurance company takes their cut off the top and then doles out the same amount to each one of these insureds as they die. Well, the heirs of the first person out win. He may pay in $8,000 for 1 year and then die and his heirs get back $1 million. The heirs of the last person out lose. The last person out may also pay in $8,000 a year. Trouble is, he pays it for 55 years for the heirs to get their million. The future value of those payments for an average compound growth rate of 8% is 7.3 million dollars. The bottom line conclusion to all of this is very simple. (1) Don't buy at risk life insurance if the client does not need it. (2) And if the client must buy some, don't keep it longer than the client absolutely must have it.

Future System Life Insurance Product Model Investment Performance

The inventors discovered why the annuity performs so well in the long run, and this discovery was helpful to ascertain the actuarial reason for such performance. An analysis of all these policies resulted in a finding that all the life insurance policies except the annuity had one characteristic in common. They all had a stated initial minimum death benefit. It is obvious that all these policies are based on an initial amount of death benefit. Life insurance policies historically have been designed based on an initial minimum death benefit. Actuarially, annuities are also life insurance polices. A single premium annuity is a single premium life insurance policy with a 0% reserve interest rate (a reserve is money set aside to cover the cost of claims). However, the inventors noticed that annuities' death benefits are not a stated initial minimum amount but rather are defined every day as a 1 to 1 ratio to cash value (cash value is the amount of premium paid in plus earnings minus what is paid out in benefits, operating costs and other expenses), so the total death benefit amount varies daily. This is why the annuities' “at risk amount” is always zero (“at risk amount” is the difference between the death benefit of a life insurance policy and the cash value of the life insurance policy).

The inventors then inquired: Is it possible for a life insurance policy, even though it had not been done before, to not have an initial amount of death benefit, like an annuity? The resulting discovery affirmed that it is possible for a life insurance policy to not have an initial amount of death benefit, like an annuity. This discovery resulted in a paradigm shift. The inventors developed a life insurance product that is designed and functions in a similar manner to an annuity. The Future System Insurance Product does not have an initial fixed death benefit but rather its death benefit is defined as a ratio to cash value and varies daily as cash value varies daily, similar to an annuity. The only difference is that the ratio is not 1 to 1 or else it would be an annuity. Instead, the inventors applied a taxation and insurance regulation or rule called the “net single premium ratio” or NSP. The net single premium ratio is the lowest ratio by law that the client can have so that a given insurance policy will be considered a “life insurance policy” under the IRS tax rules and life insurance regulations and the benefits paid out by said policy will be tax free. The Future System Life Insurance Product Model adjusts the at risk death benefit at NSP daily to make sure that the client is buying the least amount of at risk death benefit every single day of the client's life so that the client's cash value grows like an annuity, but the client still retains the tremendous tax advantages of life insurance.

The idea of a stated initial minimum death benefit was always considered necessary by actuaries and even considered to be a “good thing”. But, the inventors found out that it's the culprit. It's the part of an insurance policy that makes it mandatory that the client buy more at risk death benefit at any or all points in time than is either needed to qualify as life insurance, or more than the client may want. This makes a traditional life insurance policy inefficient at best but the initial minimum death benefit is also the factor in a life insurance policy that can cause explosion or a policy lapsing later in life if the client runs out of cash value to pay for the COIs.

FIG. 2 is the graph of the Death Benefit Amounts of a Future System Life Model insurance policy along with the prior graphs of Traditional Life Insurance and a Deferred Annuity. The Future System Life Insurance Product Model does not have the annuity's tax problem at death so that the death benefit after taxes of a Future System Life Insurance Product Model policy for a longer than expected life is much greater than that of an annuity, and greater than that of a traditional life insurance policy that would force a lot more at risk death benefit to be paid for along the way.

Summary: the Future System Life Insurance Product Model

In order for the Future System Planning Strategies to work at full efficiency, it was necessary to invent a new form of life insurance. This need is evident if one reviews the characteristics of traditional life insurance products against the role that life insurance plays as a Category 4 asset. That role is efficient wealth accumulation, asset protection, and transfer.

Existing forms of life insurance fail due to three primary reasons which do not meet the requirements of the Future System.

A. Inefficiency Due to Fixed Minimum Initial Death Benefit.

Almost all existing forms of life insurance (term, whole life, universal life, variable life and variable universal life) have a fixed initial minimum death benefit. This makes them provide much more initial death benefit than is needed to qualify as life insurance under Internal Revenue Code section 7702. This added death benefit makes them less efficient for wealth accumulation. The only exception is single premium life insurance under the cash value accumulation test of section 7702. However, single premium life insurance cannot accept the transfer of assets (as required by the Future System Planning Strategies) after the date of issue, and is therefore inadequate.

B. Inability to Assure Continuance for Life without Added Cost of Guarantees.

For life insurance to fulfill its wealth transfer role, it must remain in force for the entire life of the insured, even if that is to age 90 or 100 or beyond. Existing forms of life insurance either fail to ensure that continuance or do so only with significant added cost of guarantees, which further reduces the efficiency of the product for wealth accumulation. Here is how that applies to each product type. 1. Term insurance, by its definition, does not provide lifetime coverage. 2. Whole life insurance provides lifetime coverage, but at the cost of having a minimum guaranteed interest rate and guaranteed principal for all cash values, which creates significant additional capital requirements and therefore added cost. 3. Universal life also has added cost due to its minimum guaranteed interest rate and guaranteed principal for all cash values, and in addition may have further added cost due to secondary guarantees. 4. Variable life and variable universal life do not provide lifetime coverage without the added cost of secondary guarantees.

C. Insufficient Flexibility or Inadequate Investment Alternatives

Term and whole life do not provide for an irregular pattern of premium payment that may be needed for a client under the Future System Planning Strategies. Term, whole life, and universal life only provide general account investment of cash values, which may be inadequate in terms of investment alternatives. Variable universal life may not provide the ability to pay the premiums produced by the planning strategies at future dates, if those would cause the amount of insurance to be increased.

Why the Future System Life Model succeeds

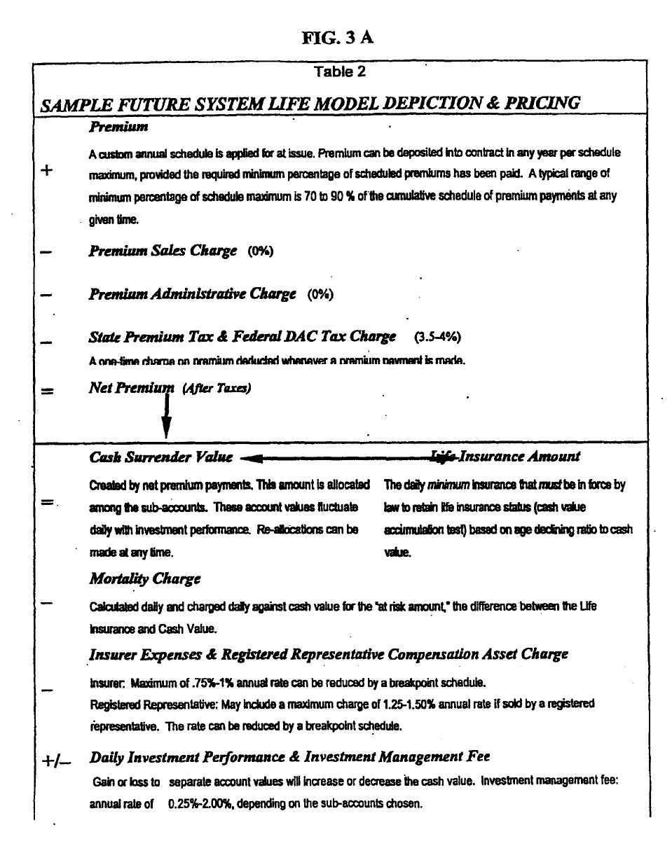

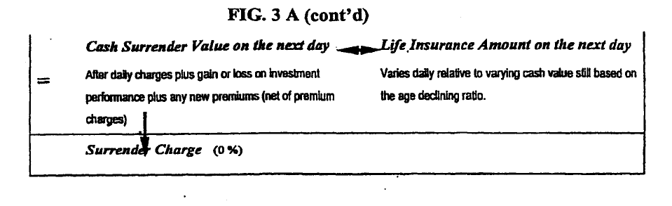

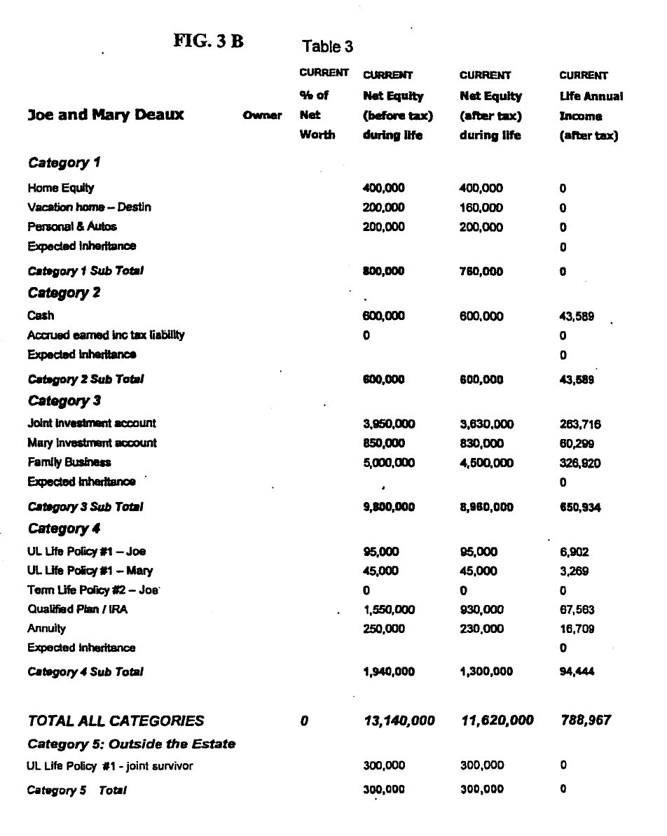

Products that conform to the Future System Life Insurance Product Model succeed because they fulfill the requirements of the planning strategies without the drawbacks of existing forms of life insurance. This is because the Future System Life Insurance Product Model was conceived specifically for the Future System Planning Strategies. The Future System Life Model provides the needed flexibility in terms of premium payment patterns, because a premium schedule, not an amount of insurance, is applied for. The client can purchase, in any given year, additional Life Model coverage per the premium schedule. This is essential within the Future System Planning Strategy. It provides adequate investment alternatives because it is a form of variable life insurance with a full range of investment sub-account choices. The client can self direct the assets in the Life Model into one or more investment sub-account choices. Furthermore, it cannot lapse due to non-payment of premiums, without any added cost of secondary guarantees. Each day, the Life Model calculates the at risk death benefit and the Life Model system operator (typically an insurance company) withdraws the daily premium charge for the at risk value. Finally, the Future System Life Insurance Product Model has maximum wealth accumulation efficiency because it always provides the minimum amount of death benefit that a life insurance product can provide and still be considered life insurance under U.S. tax and insurance law (i.e. IRC section 7702). These features are demonstrated in the depiction of the operation of the Future System Life Insurance Product Model shown in Table 2 of FIG. 3A.

Others attempted to solve the aforementioned problems with certain financial planning systems. Financial planning systems have come from the discipline served by the developers, such as from those serving investment advisors, or life insurance agents, or CPAs, or fee based planners, or tax attorneys. Their solutions fit the training and thought processes of the particular discipline that they serve. These single-discipline solutions were not accepted by advisors of other disciplines, or were too complex for clients and all advisors to understand and agree upon. Most importantly, financial planning systems do not provide integrated solutions that simultaneously solve all of a client's important financial and lifestyle issues, leaving no gaps.

The surprising result discovered by the inventors involved forcing solutions to the problem that all advisors could agree upon. The result was a revolutionary set of solutions that no single discipline currently recommends. Thus, there is not really an idea closest to what the inventors are doing, which in many ways, is antithetical to current generally accepted planning strategies. Furthermore, without the invention of a new type of life insurance, the other methods could not achieve the same results.

Life insurance and other annuity products fail for the following reasons. The insurance industry has tried to make annuities act like life insurance and overcome the annuity's death tax problem by adding on something called a bonus gain at death option for an extra cost. This extra bonus gain is nothing more than buying term insurance to cover the taxes on the gain. But there is a problem with this which makes it a very poor solution at best. The extra gain is also taxable. However, the insurance company does not charge less money for this extra death benefit because it's taxable. The insurance company cannot afford take on that cost burden of the client. The consumer pays for the gross cost of insurance charges for only a net after tax death benefit. It seems improper for the IRS to collect 40% of a client's life insurance benefit.

At the other end of the spectrum, insurance companies have tried to make universal life policies look like annuities by over funding them with extra premium. The basic flaw in this universal life design is a fixed minimum death benefit which guarantees that at some point in the client's life he or she will pay for more at risk death benefit than is needed or wanted, which makes this solution also inefficient.

Tax and Explosion Solutions

The inventors have, in essence, developed a solution to the annuities death tax problem and at the same time solved life insurance explosion problems. The inventors also provide this new life insurance product without the cost of no-lapse guarantees. How much does a no lapse guarantee cost? Million dollar UL (universal life) policies, at age forty five have been routinely selling for years for three to four thousand dollars a year of projected “not to lapse” premium. But when policies started lapsing, insurance companies started wanting more guarantees for that death benefit. Actuaries responded to this provision and indicated that if the companies were to guarantee this payout at death, the client must pay eight thousand per year. This scenario shows how dangerous a lot of these old, under funded, UL policies operate and the expense of “no lapse” guarantees.

The Future System Life Insurance Product Model cannot explode by running out of cash value or lapse by non-payment of premiums because of its efficient design without any guarantee added costs or waste of client's money.

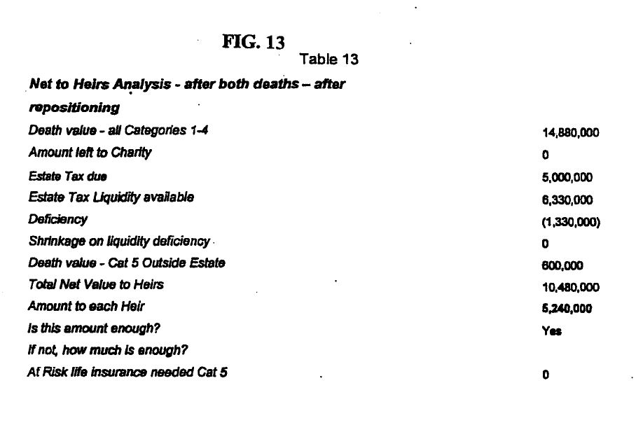

An example of one way to practice the invention follows. This example uses the Future System Planning Strategies, FACT, and the Future System Life Insurance Product Model for a hypothetical client, Joe and Mary Deaux. The example uses FIGS. 3B-13 which show Tables 3-10. These tables diagrammatically illustrate a data structure in the Future System computer program and Tables 3-13 represent outputs, in the form of spreadsheets or program outputs (for FACT) where financial calculations are performed using known mathematical functions. Use of the spreadsheet and data structure allows the user-client-advisor to observe the output and the calculation of formulas and to substitute or input data into the Future System Planning Strategies Computer Program and change the data in the data structure in order accomplish the aforementioned items and objectives. Spreadsheet programs, data base programs and other mathematical functional programs may be used herein to operate on the data structure.

As a first step, the client inventories his or her assets and the system places each asset in an appropriate asset Category. The system seeks answers to a series of questions prior to assigning an asset to a certain asset category. These assets include data representing financial data on client owned or controlled homes, boats, automobiles, jewelry, planes (asset category I or “CAT I”), cash and cash equivalents such as checking, savings, money market accounts, certificates of deposit, treasury bills, earned income, passive investment ordinary income distributions, passive investment ordinary income dividends (CAT II), securities managed tax efficiently, tax-free income producing securities, sheltered income producing securities, qualified dividend stocks, individual stocks that are held long term, municipal bonds, municipal bonds funds, equity in closely held companies, investment real estate, other relatively tax efficient, unprotected assets taxed at a capital gains tax rate, non-taxable or tax deferred (CAT III), tax deferred financial products such as annuities, qualified retirement plans, non-qualified retirement plans, IRA's, simplified employee pensions (SEP's) and life insurance (CAT IV). Category I assets also include non-income producing assets, non-liquid assets, and non-consumable assets. Client assets classified in asset category II also include client assets designated for emergencies, business and personal asset acquisition opportunities, capital expenditures, operating capital, and current estate tax liquidity. Client assets classified in asset category III include client assets designated for wealth accumulation, a source of income for living expenses after retirement and for current estate tax liability. Client assets classified in asset category IV include client assets which are exempt from creditors in bankruptcy and client assets which are tax inefficient funding products. The user of the invention assigns a number of separate functional values to each asset, as shown in Table 3 (FIG. 3B). The assets are classified in one of the asset categories I, II, III and IV. Asset category V is also used for charitable gifts. Assignment of asset to a category establishes the data in the data structure of the present invention.

The values assigned or input for each asset are net equity before tax value and net equity after tax value. (Net equity is the cash value of an asset after it has been sold and expenses, such as outstanding loans secured by said asset, have been paid for.)

The system then calculates a “life annual income” for each asset which represents income that each asset can generate over the client's life time based on a financial payment formula. The financial payment formula enables the user-client-advisor to change many variables therein such as interest rate, life expectancy, the amount (if any) of principal to retain, and the rate at which the payout should be indexed for inflation. (Life annual income is the income per year that an asset can produce for the expected life of the owner of that asset. Lifetime income can be calculated using known means using initial values for cash value, compound growth rate and inflation). The amount calculated by the financial life annual income formula can be overridden upon user-client-advisor command with a zero (-0-) for assets that will not produce income, or a flat amount of income that will be withdrawn from the asset. The system subtotals the values for each Category and totals the amount for all four asset Categories inside the Estate in the data structure. Exemplary values for Joe and Mary Deaux are shown in Table 3 (FIG. 3B).

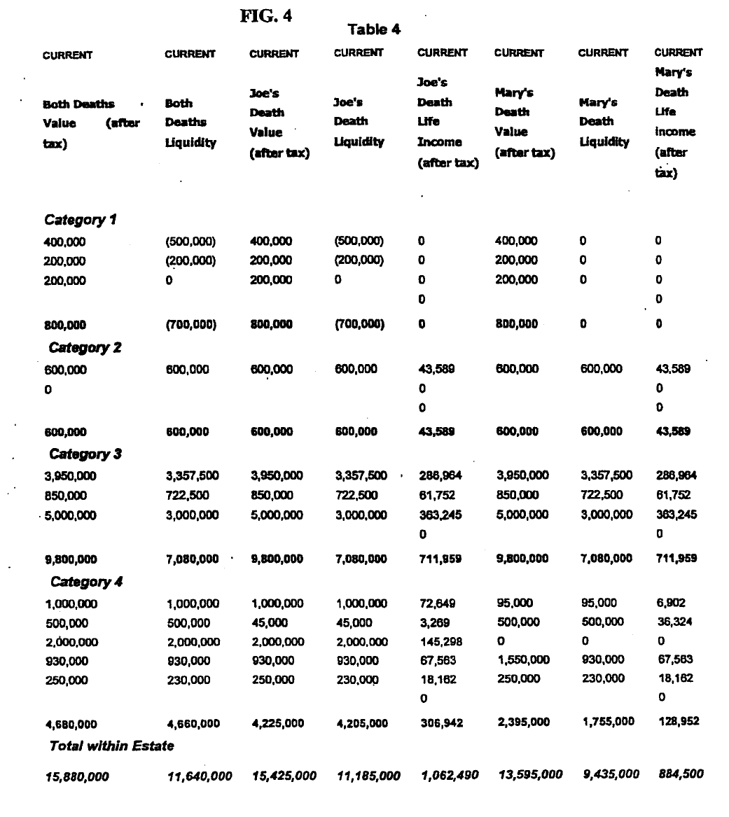

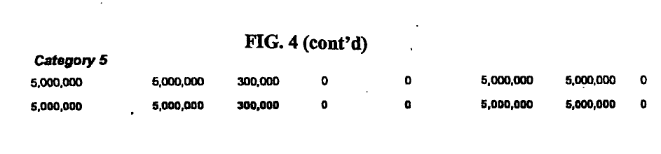

Next, the system, with input from the client-advisor, assigns the estate tax value and liquidity available at the death of both spouses for each asset, as shown in the first two columns of Table 4 in FIG. 4. (The assets are the same as those shown in Table 3.) Operationally, the system obtains and assigns for each asset a current estate tax value and a current liquidity at-death value for each estate condition from the group of estate conditions consisting of (a) death of both the client and the client's spouse, (b) death of client and survival of the client's spouse, and (c) death of the spouse and survival of the client. These values are stored for each asset in the respective data structure asset category. A negative liquidity value means that a mortgage must be paid off upon sale of the asset or the present value of some other series of cash flows assigned to the asset is negative. The advisor then assigns the estate tax value and liquidity available from each asset if only one spouse dies (an estate condition). The income that can be generated for each asset is also calculated or overwritten by -0- or overwritten by a pre-set amount. Exemplary values for Joe and Mary Deaux are shown in Table 4 (FIG. 4).

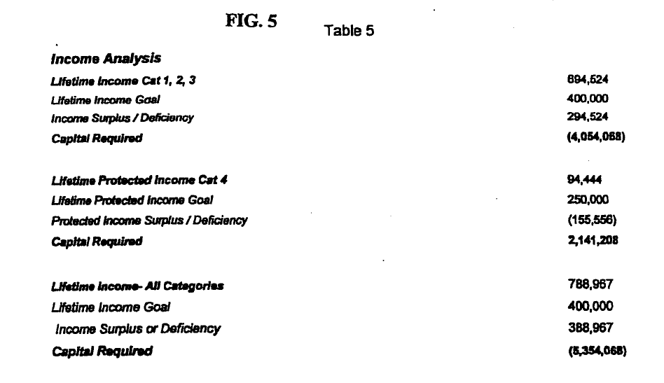

The system also calculates a post-death annual income for each estate condition (no survivors, client as survivor, and spouse as survivor). The post-death annual income reflects income after taxes. The data post-death annual income is stored for each asset in the respective data structure asset category. Based on the foregoing data, the system calculates the lifetime (after tax) income amount currently annually available from assets in categories 1, 2, and 3 combined. This is compared to the client's goal for annual lifetime income. The client or advisor inputs the client's annual lifetime income into the data structure. As shown in the first section of Table 5 (FIG. 5), the goal in this example is $400,000 per year and the amount that can be generated by the current assets in that category is $694,524, or $294,524 more than the input goal. The system calculates that the combined assets in categories 1, 2. and 3 are $4,054,068 more than needed to provide the lifetime income goal.

The lifetime protected annual income goal differs from the lifetime annual income goal, and the lifetime protected annual income goal is the minimum amount that the client would accept as income if all assets in Categories 1, 2, and 3 were lost (involuntarily transferred), such as through lawsuits or bankruptcy. In this example, the “protected” income available from Category 4 assets is $94,444 and therefore does not reach the client's protected income goal of $250,000. The shortfall of $155,556 will be remedied over time by moving $2,141,208 of assets from Categories 1, 2,& 3 to Category 4. When this is completed, the client will be “In balance”. (“In balance” means that the distribution of assets and amount of assets in the different categories is consistent with the client's financial goals). This transfer, in one example of the present system is accomplished by the system sending instructions to the client's bank and brokerage service to shift assets or sell or liquidate assets and buy Category 4 (IV) assets. In another embodiment, training and instructions on the use of the financial plan indicate what actions are needed based upon the system output. In this other embodiment, the client or the client's asset manager is responsible for carrying out the actions. Table 5 in FIG. 5 also shows that if the assets in all categories were used, the income would be $388,967 more than the goal and that there is over $5 million more than needed to produce the lifetime income goal. (“Life annual income” and “lifetime income” refer to the same entries in the data structure).

In other words, the system combines life annual incomes for all assets in categories I, II and III to obtain a projected, combined life annual income. Also, the system combines the life annual incomes for all assets in category IV to obtain a projected, protected combined life annual income. Assets in category IV are protected from lawsuit creditors and from bankruptcy. The client and his or her advisor, inputs or obtains the client's life annual income goal and a client's protected life annual income goal into the data structure. The protected life annual income goal is a minimum amount acceptable to said client if all assets in asset categories I, II and III were involuntarily transferred due to bankruptcy or lawsuits. The system identifies surpluses and deficiencies between: (a) the projected, combined life annual income and the life annual income goal; and (b) the projected, protected combined life annual income, and the protected life annual income goal. The system calculates a projected combined capital to account for said surpluses and deficiencies, respectively. The “Capital Required” for each condition is shown in Table 5 (FIG. 5).

The system stores, in the data structure, the projected, combined life annual income and the life annual income goal and the projected, protected combined life annual income and the protected life annual income goal and the respective projected combined capital to account for said surpluses and deficiencies, and displays the same, upon command.

To achieve “balance,” in the event of a surplus between the projected, combined life annual income and the life annual income goal, then the system instructs the client, or the client's asset manager (email or electronically or otherwise) to either (i) transfer assets from categories I, II and III to category IV or (ii) liquidate assets from categories I, II and III and purchase assets for category IV based upon the projected surplus-deficiency combined capital.

In the event of a deficiency between the projected, protected combined life annual income, and the protected life annual income goal, the system either notes the need for an adjustment or communicates an adjustment of category assets to the client's financial fiduciaries by either (i) transferring assets from categories I, II and III to category IV or (ii) liquidating assets from categories I, II and III and purchasing assets for category IV based upon the projected surplus-deficiency combined capital or (iii) revising the client's life annual income goal and client's protected life annual income goal and re-calculating surpluses and deficiencies, and re-calculating the projected combined capital and re-adjusting the category assets.

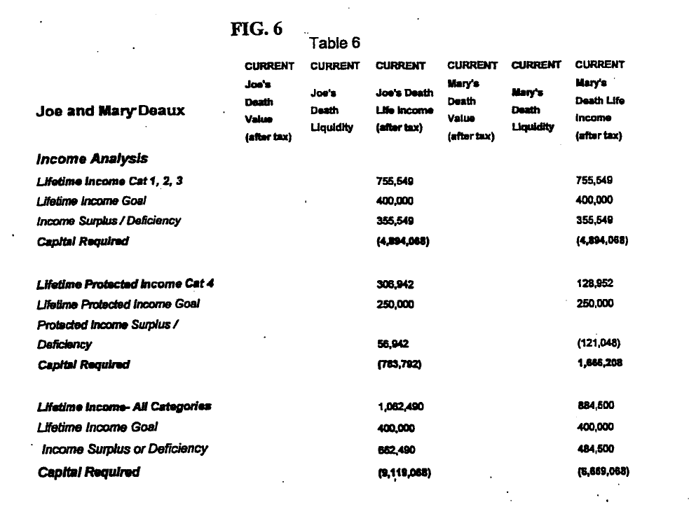

Next, the system operates on the surviving family income analysis. This is shown in FIG. 6 and Table 6. This data structure shows a surplus (more assets than needed) in the event of Joe's death, compared to the both the lifetime income and protected income goals for his family. In the event of Mary's death, there are more than enough assets in Categories 1, 2, & 3 to meet the lifetime income goal, but a deficiency with respect to the protected income goal.

In the either event, however, the total lifetime income available from assets in all categories is substantially greater than the goal. This data structure output informs the advisor that the client-Joe may have as much as $9.1 million of at risk death benefit more in Joe and Mary's traditional life insurance policies than they need. The amount of this at risk death benefit, therefore, can be reduced or eliminated.

In other words, the system combines the post-death annual incomes for the estate conditions (a), (b) and (c) for all assets in categories I, II and III to obtain a projected, combined post-death annual income. The system also combines the post-death annual incomes for all estate conditions for all assets in category IV to obtain a projected, protected combined post-death annual income wherein the post-death annual income includes any life insurance proceeds on either the client or the spouse or both. The system identifies surpluses and deficiencies between: (a) the projected, combined post-death annual income and the life annual income goal; and (b) the projected, protected combined post-death annual income and the protected life annual income goal. It also calculates a projected combined post-death capital to account for the surpluses and deficiencies, respectively. The life annual income goal and the protected life annual income goal was previously entered with respect to Table 5, FIG. 5.

The system stores, in the data structure, the projected, combined post-death annual income for all estate conditions and the life annual income goal and the projected, protected combined post-death annual income for all estate conditions and the protected life annual income goal and respective projected combined post-death capital to account for the surpluses and deficiencies. This data is displayed upon command. See Table 5.

In the event of a surplus between the projected, combined post-death annual income and the life annual income goal, the system communicates with the asset advisor/manager (or otherwise displays recommendations) to either (i) transfer assets from categories I, II and III to category IV or (ii) liquidate assets from categories I, II and III and purchase assets for category IV based upon the projected surplus-deficiency post-death combined capital. In the event of a deficiency between projected, protected combined post-death annual income and the protected life annual income goal, the system adjusts category assets by either (i) transferring assets from categories I, II and III to category IV or (ii) liquidating assets from categories I, II and III and purchasing assets for category IV based upon the projected surplus-deficiency post-death combined capital or (iii) revising of the client's life annual income goal and client's protected life annual income goal and re-calculating surpluses and deficiencies, and re-calculating the projected combined post-death capital and re-adjusting the category assets, or (iv) purchasing additional life insurance to fill the deficiency between projected, protected combined post-death annual income and the protected life annual income goal.

In the event of a surplus between projected, protected combined post-death annual income and the protected life annual income goal, the system seeks to reduce the value of life insurance assets in category IV. This reduction frees up income to be otherwise saved in Category IV.

The next analysis performed by the system on the data structure is the estate tax liquidity analysis, which is shown in FIG. 7 and Table 7. This process involves analyzing the client assets to determine a current estate tax liquidity for each respective asset and each asset category and identifying a need for term insurance. The taxable estate would be $15,880,000 with an estate tax of $6 million. There is $16,640,000 of liquidity available so there will be no shrinkage due to the forced sale of assets. There is also $5 million of proceeds from outside the estate from a second to die life insurance policy, so the net estate distributed to heirs after taxes is $14,880,000 or $7,440,000 per child. The client says this is more than enough so no additional term life insurance is needed.

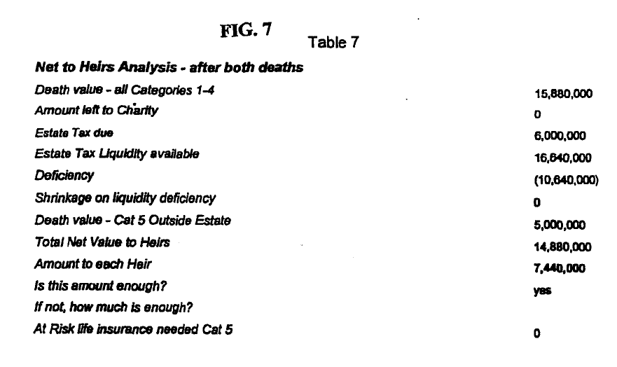

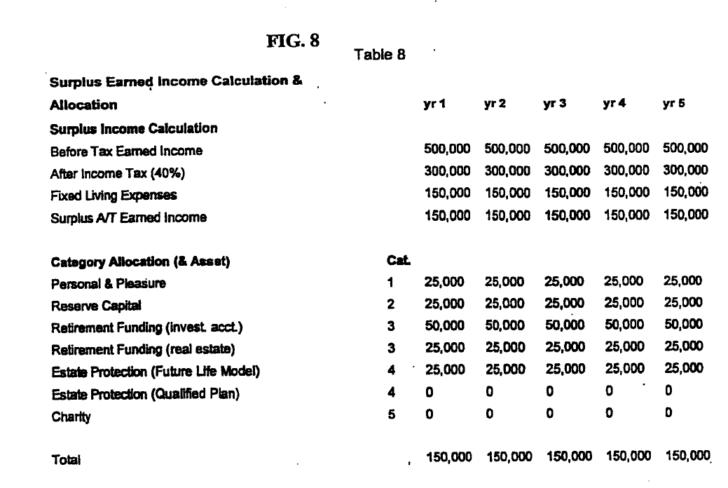

Next, the system analyzes the client's cash flow to determine surplus earned income. This is allocated into the different asset categories in proportion to the amount needed in each category to meet the client's objectives, until each category is fully funded and in balance. An illustrative calculation and set of allocations for Joe and Mary Deaux (for the first 5 years) are shown in FIG. 8 and Table 8. Table 8 shows before tax earned income, after tax (A/T) income, fixed living expenses and surplus after-tax (A/T) earned income.

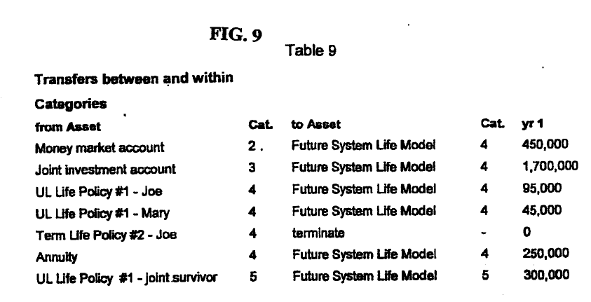

Next, the system determines transfers between asset categories and assets to help bring the clients' holdings into “balance.” These transfers for Joe and Mary Deaux are shown (for year 1) in the FIG. 9 and Table 9. In this case, there are already more than enough Category 3 assets to support retirement income goals, so excess Category 2 and Category 3 assets are moved to Category 4, Future System Life Insurance Product Model. The excess “at risk death benefit” insurance is eliminated by moving cash values of existing UL policies (i.e. Universal Life Insurance) to the Future System Life Insurance Product Model in both Categories 4 and 5. Annuity values that are not needed for income in Category 4 are also transferred to Future System Life Insurance Product Model.

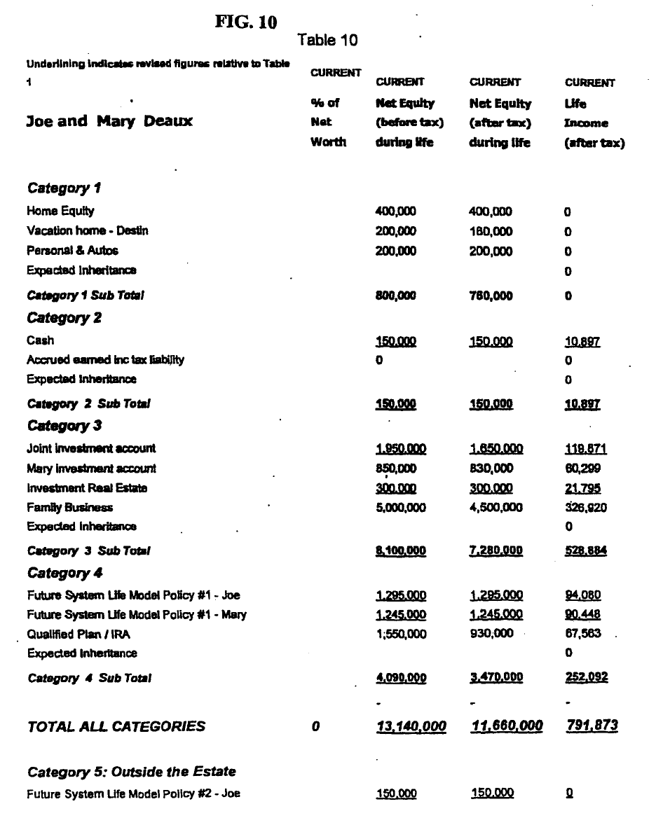

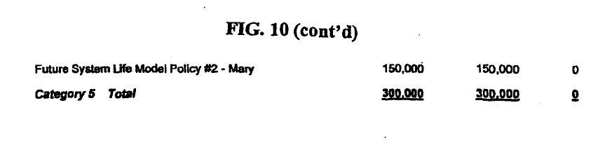

The system also provides for minimum distributions from qualified plans to be transferred to Future System Life Insurance Product Model when required. The combination of surplus earned income allocation and the transfers between and within categories (both initial and subsequent) create a plan of action steps to meet the clients' goals and bring their financial life into balance over time. The results of these planned changes are shown in FIG. 10, Table 10.

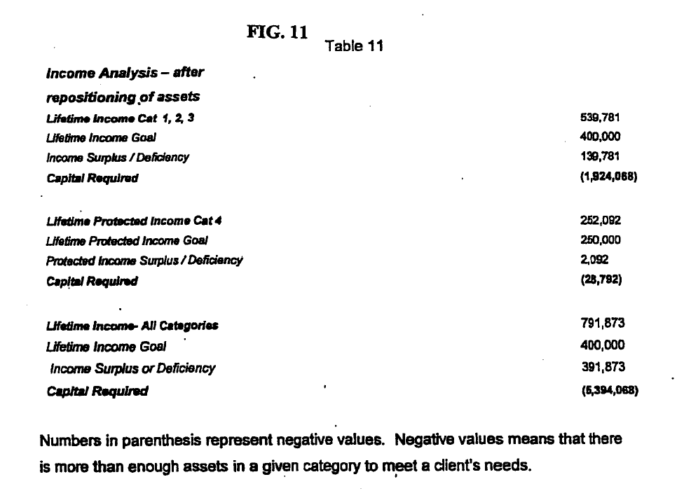

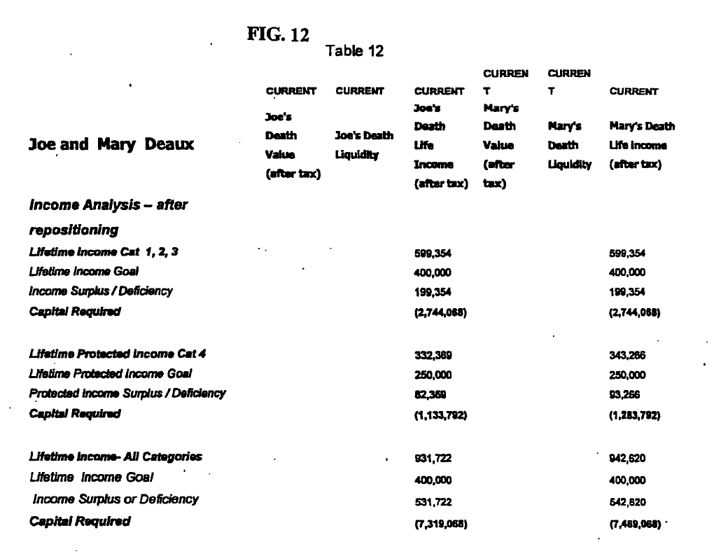

After the changes within and between categories, the client's goals are now met for both lifetime income and protected income, as shown in FIG. 11, Table 11. Numbers in parentheses in Table 11 represent negative values. Negative values means that there is more than enough assets in a given category to meet a client's needs. Furthermore, even with the reduction in at-risk death benefit, the survivor income goals in the event of the death of either spouse are also met, as shown in FIG. 12, Table 12.

The calculation of “Life Annual Income” is described below and calculated by Equation 100.
Life income=PMT (income rate, joint life expectancy, principal amount) Eq. 100

Where: (a) Life income is the amount of annual income a person will receive from a given principal amount invested in a financial vehicle (e.g. a deferred annuity) that earns income rate percent per year. Life income is a before tax amount. (b) PMT is the Excel® function PMT. (c) Income rate is the rate at which a given investment earns income. income rate may be corrected to take into account an anticipated inflation rate. (d) Joint life expectancy is the longest life expectancy of all persons who are beneficiaries of the financial vehicle. (e) Principle amount is the amount invested in said financial vehicle.

An explanation of one method of underwriting the Future System Life Insurance Product Model is set forth below. The Future System Life Insurance Product Model presents a unique underwriting challenge. The inventors formulated the following equation for the “underwriting amount”. “Underwriting” is the process by which an insurance company determines if a given insured can be granted an insurance policy they requested. “Underwriting amount” is the amount of death benefit that the insurance company believes that it must review under its established underwriting policies and practices. For traditional life insurance, the underwriting amount is simply the face amount of the insurance policy. For a Future System Life Insurance Product Model insurance policy, it has been discovered that a suitable underwriting amount, UAₓ, can be calculated by any one of equations 102, 104 or 106 below. The term x is the age of the insured when the Future System Life Insurance Product Model insurance is issued. In a preferred embodiment of the present invention, the maximum value of equations 102, 104 or 106 is used as the underwriting amount. These equations are based on an applied for set of future premium payments, (Pmmₜ) where each premium is expected to be paid in year t. They are also based on a net single premium, NSP y, for a given insured at age y. The Net Single Premium (NSP) is the maximum amount of premium (after expenses) that will purchase $1 of whole life insurance benefit at a given age y of an insured such that the life insurance benefit payment will receive favorable (e.g. no tax) treatment. In the U.S., this is based on the applicable mortality table (a table that indicated the probability of an insured dying at a given age y) and interest rate for the “cash value accumulation test”, as described in U.S. Internal Revenue Code section 7702. Other jurisdictions may have comparable requirements. NSP y would then be calculated according to the rules of said jurisdictions. NSP y is typically in the range of 0.15 to 0.85 for adult ages. Approximate NSP values in the U.S. as of 2006 are: age 30, female=0.15, male=0.17; age 50, female=0.30, male=0.34; age 70, female=0.54, male=0.60, age 90, female=0.81, male=0.85

Equation 102 is:
UAₓ=Premₓ(*)(1−E)(*)the inverse of NSPₓ

Where: (a) E is the fraction of a given premium that is assessed as a state premium tax and federal DAC tax. E is typically in the range of 0.035 to 0.04 (i.e. 3.5% to 4.0%). (b) (*) is the symbol for multiplication. (c) The inverse of NSPₓ is (1/NSPₓ).

Equation 104 is:
UAₓ=(SUMMATION t=1 to 10)Premₜ(*)(1−E)(*)(1−NSPₓ₊₁₀)(*) (the inverse of NSPₓ₊₁₀)(*)(1+iₜ−i^{e}−iₜ^{M&E}−iₜ^{coi})^{(10-t+1)}
Equation 106 is:
UAₓ=(SUMMATION t=1 to k)Premₜ(*)(1−E)(*)(1−NSPₓ₊ₖ)(*) (the inverse of NSPₓ₊ₖ)(*)(1+iₜ−i^{e}−iₜ^{M&E}−iₜ^{coi})^{(k-t+1)}

Where: (a) k is the policy year less than 20 in which the greatest premium Prem k is applied for. (b) iₜ=assumed gross rate of return in policy year t. (c) i^{e}=assumed investment management fee as a percent of cash value. (d) iₜ^{M&E}=assumed mortality and expense charge as a percent of cash value in policy year t. (e) iₜ^{coi}=assumed cost of insurance charges as a percent of cash value in policy year t. When superscripts are used with respect to i variables, they denote labels. When superscripts are otherwise used, they denote exponents.

There is a method to translate conventional at-risk cost of insurance charges to charges based on cash values, and further to levelize the charges for periods of 10 to 20 years. This was possible under reasonable investment assumptions because of the unique product design.

Equation 110
CVₜ=(SUMMATIONs=1 to t)Premₜ(*)(1−E)(*) (1+iₛ−i^{e}−iₜ^{M&E}−iₛ^{coi})^{(t-s+1)}

Where: (a) CVₜ is the cash value of the insurance policy in policy year t. Then levelized cost of insurance charges, iₜ^{coi} (as a fraction of cash values for a particular risk class and issue age x) can be calculated by solving the following equation 112.

Equation 112
(SUMMATION t=m to m+n−1)iₜ^{coi}(*)CVₜ(*)ₜpₓ(*)(1+iᵢᵣᵣ) ^{m+n-t-1}=(SUMMATION t=m to m+n−1)coiₜ(*)((CVₜ divided by NSPₓ₊ₜ)(*)(1−NSPₓ₊ₜ))(*)ₜpₓ(*)(1+iᵢᵣᵣ)^{m+n-t-1}

Where: (a) coiₜ=cost of insurance charges based on the net amount at risk for policy year t. (b) ₜpₓ=probability that an individual in the risk class insured at age x will survive for t policy years, and (©)iᵢᵣᵣ=carrier internal rate of return required, and (d) n=the number of policy years for which a levelized charge is to be calculated starting in policy year m.

In all of the above equations, the formulas given are approximations based on annual calculations, and it is understood that more precise computations are available through the use of monthly or daily calculations.

Some of the other challenges solved by the present invention are discussed below. With respect to sales, the new methodology must be taught to financial advisors. These issues are addressed in the Carrier Distribution Acquisition Plan which follows.

The typical users of the system will be financial advisors who want to receive part or all of their compensation as an asset based compensation. The Future System users or advisors are found in different marketing channels, such as Insurance agents, Stockbrokers, Independent financial planners. Banks and trust companies, and CPAs. These new users may not currently sell life insurance because (a) large up-front commissions are contrary to the current way these new users market themselves (they have made a conscious decision to be objective planners and to be paid in a certain way); (b) they know that life insurance policies are complicated and have historically had many traps and pitfalls (they don't know where the traps may be and don't understand enough or have enough confidence to know that they will see the traps before the sale); (©) they will not risk their reputation or the possibility of losing a large asset based investment client just to write a life insurance policy; and (d) they believe they can do better for their client long-term by investing the money and buying term life insurance for its death benefit (Term life insurance is a very simple understandable product to the client and the adviser with no tax traps).

Many independent comprehensive financial planners readily admit that their biggest weaknesses are in the areas of estate planning and life insurance since investments is the background of most. This is a big problem for planners who want to perform comprehensive wealth management services.

The Future System solves these problems. Compensation is asset based. The Future System Life Insurance Product Model is very simple with no tax traps and can be easily understood by advisor and client. It is structured similar to investment products with which they are familiar. Familiar methodology of buying term life insurance and investment is proven and supported. The Future System planning methodology makes estate planning and insurance determination very simple.

From an underwriting and reinsurance standpoint, the premium schedule causes future increases in the net amount at risk, based on the action of the policyholder, without new underwriting because the client applies for a premium schedule at the inception of the life insurance product. Normally, life insurance product rules allow the insurance company to prevent this. The inventors' approach to this issue was to develop a formula to determine appropriate underwriting and reinsurance requirements at the time of application based on the premium schedule.

Policies based on the Future System Life Insurance Product Model do not have a fixed minimum face amount, and future premiums are not required to keep policies in force. The administration of these policies requires special computer processes to handle these differences and to keep track of premium schedules and cumulative payments relative to the premium schedule.

Marketing the program is unique. A new way had to be developed to explain the financial operation of the product to the prospective buyer. The solution was to keep the design simple and to present the financial operation in a simple depiction, as shown above in the sample application.

Computers and the Internet are used in the following manner. All parts of the Future System have been developed into website, portals, web based applications and web based presentations to enable access by financial planners and clients throughout the United States. Internet website, portals, web based applications and web based presentations will be used to (i) explain the Future System to advisors who are potential users; (ii) educate advisors about the Future System Planning Strategies and Future System Life Insurance Product Model; (iii) used by advisors to explain the Future System Planning Strategies and Future System Life Model to prospective clients; (iv) to obtain realtime advice from the operators of the Future System; (v) to update and enhance the Future System information model and data structure which is available to advisors and clients; (vi) to educate the public and process the data to solve financial and estate planning problems; (vii) provide application and underwriting requirements for products based on the FutureSystem Life Model to advisors; (viii) provide policy and prospectus information for products based on the Future System Life Insurance Product Model. Computers will provide administration of unique policy features of products based on the Future System Life Model.

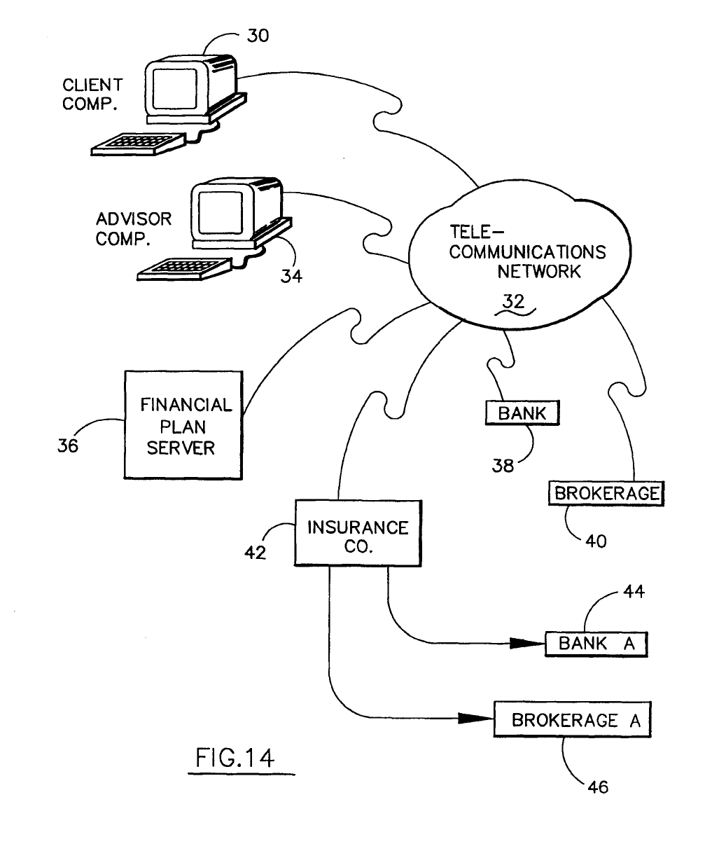

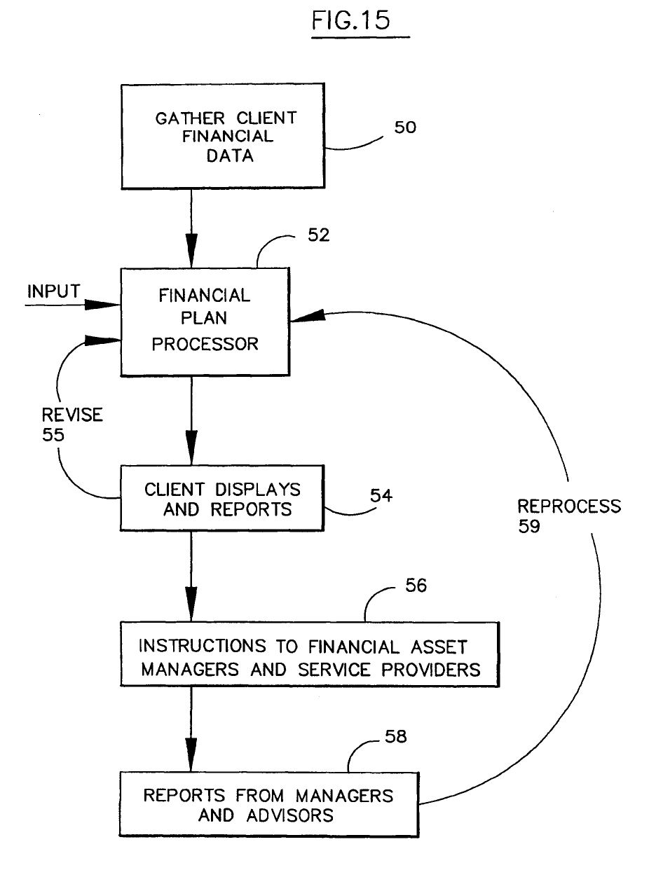

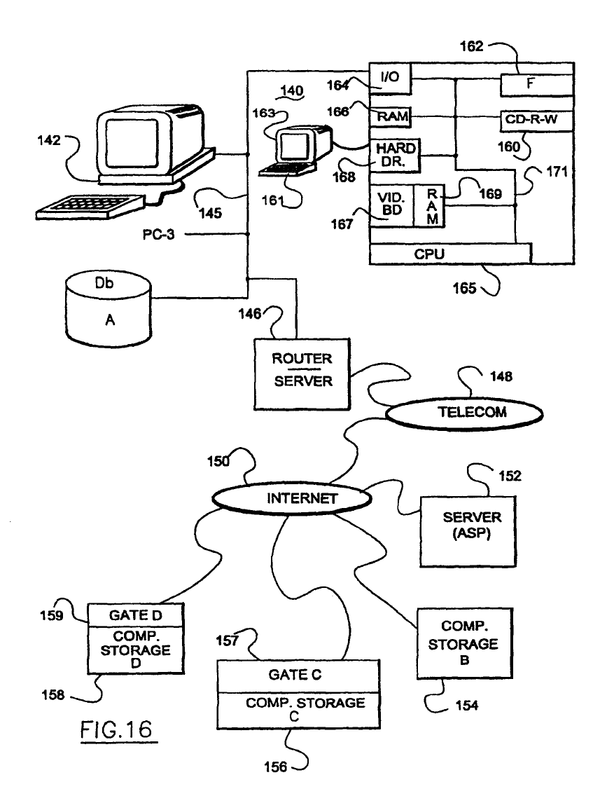

FIGS. 14-16 show the computer implementation of the present system. FIG. 14 diagrammatically illustrates a simplified computer system over which is deployed the financial planning system and process. FIG. 15 diagrammatically illustrates a simplified computer process with the financial planning system. FIG. 16 diagrammatically illustrates another computer system over which is deployed the financial planning system and process.

In FIG. 14, client computer 30 and advisor computer 34 are coupled to a telecommunications network 32, typically, the Internet, but a wide area network or LAN or a private Internet (Extranet) may be employed. The data structure described above resides on the financial plan or planner server 36. At the initial input, advisor computer 34, which may be a laptop, accepts input from the advisor based upon questions posed to the client. Alternatively, the client may enter data as per the advisor's instructions. Asset data from the client may be electronically obtained from bank computer 38, brokerage house computer 40 or insurance company computer 42. The insurance company computer 42 works with other bank computer(s) 44 and brokerage computer(s) 46 to manage the client's assets, especially those within the life insurance model.

After entry of the initial data, the Plan server 36 processes the data as per the description set forth above and outputs a plan to both the advisor and the client via computer 30, 34. To transfer assets between categories and the continually monitor and update the plan, the Plan server 36 (based upon security clearance of the client) accesses bank 38, brokerage 40, insurance company 42 and the associated bank A 44 and brokerage A 46 computers. This permits the plan server 36 to keep current with the monthly or daily changes in the client's portfolio under the Future System Plan described above. Daily analysis is necessary for the Life Model Product. Also, the client and the adviser may effect the transfer to assets between categories by providing electric instructions to bank 38, brokerage 40, insurance company 42 and the associated bank A 44 and brokerage A 46 computers.

FIG. 15 diagrammatically illustrates a simplified computer process with the financial planning system. Initial step 50 gathers client financial data into the data structure described above. Step 52 processes the data as described above. Additional input is noted into processor step 52. An example of these additional inputs are the variables for the life annual income described above. Other inputs are discussed above. The output of the processor 52 is the spread sheet data structure Tables 2-13 described above. This functional step is shown in FIG. 15 as client displays and reports 54. The displays are shown on the client computer and advisor computer 30, 34. Step 56 shows that instructions are sent to financial asset managers and asset service providers that are generally shown in FIG. 14. Step 58 is a report from these managers and advisors. The system re-processes 59 the updated data from the managers and the updated data is applied to the Plan Processor 53. Further, after the program displays the reports to the client and the advisor, the system permits revisions 55 to be made. These revisions 55 are applied to the Plan Processor 52.

### General System Comments

It is important to know that the embodiments illustrated herein and described herein are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views. The section titles are not meant to limit the detailed description of the system and process described therein.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits. Furthermore, the computer readable medium may include computer readable information in a transitory state medium such as a network link and/or a network interface, including a wired network or a wireless network, that allow a computer to read such computer readable information.

In the drawings, and sometimes in the specification, reference is made to certain abbreviations. The following Abbreviations Table provides a correspondence between the abbreviations and the item or feature.

### Abbreviations Table

bd board
CD-RW compact disk drive with read/write feature for CD disk
comp computer
CPU central processing unit
DB or db data base or structured data file
dr drive, e.g., computer hard drive
F floppy computer drive or flash drive memory
I/O input/output
mem memory
PC personal computer or any other type of general computer
sys system
t time
tele-com telecommunications system or network

FIG. 16 diagrammatically illustrates a personal computer or PC computer system 140, a second PC or computer 142, and a third PC-3. PCs 140, 142 and PC-3 are connected together via a network 145 (LAN or WAN) and connected to one or more private databases, spreadsheets or data structures which are represented by Db A. The data structure described above in Tables 3-13 are found in either Db A or in computer storage B. Computer storages C and D are associated with banks or brokerage houses or insurance companies as described above in FIG. 14. The LAN 145 is also connected to an input/output device 146 that may be generally described as a router or an I/O device to an outside communications system. The input/output device 146 is connected to a telecommunications system 148 which leads to Internet 150. The Internet is a global computer network. Internet 150 is coupled to a plurality of servers, one of which is server 152. Server 152 may be designated as an application service processor ASP. The ASP in this model is the Plan Processor. The ASP provides various tools to the user on computer 142 such access to the data structures. Internet 150 also includes various computer memory storage devices such as computer storage B 154, computer storage C 156 accessible through Security Gate C 157 (via password or other control device) and computer storage D 158 accessible via Security Gate D 159. Access to computer storage C and D is permitted via security level clearance modules or Gate C and D 157, 159.

Typically, PCs include a keyboard or data input device 161, a display 163, a central processing unit CPU 165, a video board 167 having video board memory 169, a fixed disc hard drive 168, a RAM 166, and input/output device 164, a removable memory F media (flash or floppy) drive 162 and a removable compact disk (CD) read-write (CD-RW) device or drive 160. The system may include other removable disk drives, tape drives, or flash memory units. Internal units CPU 165, video board 167, hard drive 168, RAM 166 input/output device 164, floppy drive 162 and CD-ROM device 160 are all coupled together via an internal bus 171. Bus 171 represents a plurality of buses as is known to persons of ordinary skill in the art.

One methodology of implementing the present invention enables the user or operator on the PC 142 to call up an ASP on system 152 (the Financial Plan Processor) and operate Plan on the computer system 152. In a client-server environment, server 152 acts as a server generally cooperating with data operations with client computer 140. Of course, persons of ordinary skill in the art recognize that the server may be located on the local area network 145 rather than being interconnected with Internet 150 as shown in FIG. 16. The claims appended hereto are meant to cover the alternative embodiments.

As an example of a client-server or web-based implementation of the present invention, the user at computer 140 may input asset data as described above, and input data via keyboard 161 or load source data from F drive 162 or CD-ROM drive 160 into RAM 166. Alternatively, the data stream on LAN 145 may be monitored by PC 140. In any event, whether the source data is input via keyboard 161 or copied or accessed in or from F drive 162 or CD-RW drive 160, the data is processed by the Financial Plan Processor as discussed above. Off site data storage and processes are available permitting activation of server 152 and enabling the server to take over the process directly from user 140. In other words, the user at computer 140 could call up the URL of the server 152, the server could request certain user information (user name, password), and would request data from the client computer to establish asset classification pursuant to input selected by the user. The client computer may (a) process the plan or (b) send the data to the server for processing. The server could store data either locally on computer 140 or remotely at computer memories 154, 156. Either the PC or the server could conduct the processing and return the compiled data results to the PC.

The claims appended hereto are meant to cover modifications and changes within the scope and spirit of the present invention.

What is claimed is:

1. A computer readable medium containing programming instructions for a computerized process to generate a financial and estate plan using liquidity analysis comprising:
obtaining client asset data representing financial data on client owned or controlled homes, boats, automobiles, jewelry, planes, cash and cash equivalents such as checking, savings, money market accounts, certificates of deposit, treasury bills, earned income, passive investment ordinary income distributions, passive investment ordinary income dividends, securities managed tax efficiently, tax-free income producing securities, sheltered income producing securities, qualified dividend stocks, individual stocks that are held long term, municipal bonds, municipal bonds funds, equity in closely held companies, investment real estate, tax deferred financial products such as annuities, qualified retirement plans, non-qualified retirement plans IRA's, simplified employee pensions (SEP's) and life insurance;
defining a data structure with at least four asset categories I, II, III and IV;
asset category I encompasses personal assets and pleasure assets, which include homes, boats, automobiles,jewelry, planes and other client assets which provide shelter and enjoyment and enhance the owner's lifestyle;
asset category II encompasses client assets which represent reserve capital assets and include cash and cash equivalents such as checking, savings and money market accounts, certificates of deposit, treasury bills, earned income, passive investment ordinary income, distributions, and passive investment ordinary income dividends;
asset category III encompasses client assets which represent unprotected retirement funding assets and includes securities managed tax efficiently, tax-free income producing securities, sheltered income producing securities, qualified dividend stocks, individual stocks that are held long term, municipal bonds, municipal bond funds, equity in closely held companies, investment real estate, other relatively tax efficient, unprotected assets taxed at a capital gains tax rate, non-taxable or tax deferred;
asset category IV encompasses client assets which represent tax deferred vehicles and includes annuities, qualified retirement plans, non-qualified retirement plans, IRA's, simplified employee pensions (SEP's) and life insurance;
classifying each of said client assets in one of said four data structure asset categories and displaying, upon command, said classified client assets per asset category;
obtaining and assigning to each asset a net equity before tax value and a net equity after tax value and storing the same for each asset in the respective data structure asset category;
calculating for each asset a life annual income based on a financial payment formula including client modifiable variables including an interest rate variable, a life expectancy variable, an amount of principal to retain variable, and an inflation variable, said life annual income financial formula having a life annual income payout value which is indexed with said inflation variable, the respective life annual income stored for each asset in the respective data structure asset category;
obtaining and assigning for each asset a current estate tax value and a current liquidity at-death value for each estate condition from the group of estate conditions consisting of death of both said client and a client spouse, death of client and survival of client spouse, and death of a client spouse and survival of said client and storing the same for each asset in the respective data structure asset category;
calculating an post-death annual income for each said estate condition, said post-death annual income reflecting income after taxes and storing the same for each asset in the respective data structure asset category;
combining said life annual incomes for all assets in categories I, II and III to obtain a projected, combined life annual income;
combining said life annual incomes for all assets in category IV to obtain a projected, protected combined life annual income;
obtaining a client's life annual income goal and a client's protected life annual income goal, said protected life annual income goal being a minimum amount acceptable to said client if all assets in asset categories I, II and III were involuntarily transferred due to bankruptcy or lawsuits;
identifying surpluses and deficiencies between:
(a) said projected, combined life annual income and said life annual income goal; and
(b) said projected, protected combined life annual income, and said protected life annual income goal;
calculating a projected combined capital to account for said surpluses and deficiencies, respectively,
storing, in said data structure, said projected, combined life annual income and said life annual income goal and said projected, protected combined life annual income and said protected life annual income goal and respective projected combined capital to account for said surpluses and deficiencies, and displaying the same, upon command;
in the event of a surplus between said projected, combined life annual income and said life annual income goal, then either (i) transferring assets from categories I, II and III to category IV or (ii) liquidating assets from categories I, II and III and purchasing assets for category IV based upon said projected surplus-deficiency combined capital;
in the event of a deficiency between projected, protected combined life annual income, and said protected life annual income goal, then adjusting category assets by either (i) transferring assets from categories I, II and III to category IV or (ii) liquidating assets from categories I, II and III and purchasing assets for category IV based upon said projected surplus-deficiency combined capital or (iii) revising said client's life annual income goal and client's protected life annual income goal and re-calculating surpluses and deficiencies, and re-calculating said projected combined capital and re-adjusting said category assets;
combining said post-death annual incomes for said estate conditions for all assets in categories I, II and III to obtain a projected, combined post-death annual income;
combining said post-death annual incomes for said estate conditions for all assets in category IV to obtain a projected, protected combined post-death annual income, said post-death annual income including life insurance proceeds;
identifying surpluses and deficiencies between:
(a) said projected, combined post-death annual income and said life annual income goal; and
(b) said projected, protected combined post-death annual income, and said protected life annual income goal;
calculating a projected combined post-death capital to account for said surpluses and deficiencies, respectively,
storing, in said data structure, said projected, combined post-death annual income for said estate conditions and said life annual income goal and said projected, protected combined post-death annual income for said estate conditions and said protected life annual income goal and respective projected combined post-death capital to account for said surpluses and deficiencies, and displaying the same, upon command;
in the event of a surplus between said projected, combined post-death annual income and said life annual income goal, then either (i) transferring assets from categories I, II and III to category IV or (ii) liquidating assets from categories I, II and III and purchasing assets for category IV based upon said projected surplus-deficiency post-death combined capital;
in the event of a deficiency between projected, protected combined post-death annual income and said protected life annual income goal, then adjusting category assets by either (i) transferring assets from categories I, II and III to category IV or (ii) liquidating assets from categories I, II and III and purchasing assets for category IV based upon said projected surplus-deficiency post-death combined capital or (iii) permitting revision of said client's life annual income goal and client's protected life annual income goal and re-calculating surpluses and deficiencies, and re-calculating said projected combined post-death capital and re-adjusting said category assets, or (iv) purchasing additional life insurance;
in the event of a surplus between projected, protected combined post-death annual income and said protected life annual income goal, then reducing the value of life insurance assets in category IV.

2. A computer readable medium containing programming instructions for the financial and estate plan with liquidity analysis as claimed in claim 1 including accepting from a third party updated client asset data representing financial data and tracking current and future liquidity needs of said client by data asset category.

3. A computer readable medium containing programming instructions for the financial and estate plan with liquidity analysis as claimed in claim 1 wherein said client assets classified in asset category I further encompass non-income producing assets, non-liquid assets, and non-consumable assets.

4. A computer readable medium containing programming instructions for the financial and estate plan with liquidity analysis as claimed in claim 1 wherein said client assets classified in asset category II include client assets designated for emergencies, business and personal asset acquisition opportunities, capital expenditures, operating capital, and current estate tax liquidity.

5. A computer readable medium containing programming instructions for the financial and estate plan with liquidity analysis as claimed in claim 1 wherein said client assets classified in asset category III include client assets which are not exempt from the reach of creditors in bankruptcy.

6. A computer readable medium containing programming instructions for the financial and estate plan with liquidity analysis as claimed in claim 1 wherein said client assets classified in asset category III include client assets designated for wealth accumulation, a source of income for living expenses after retirement and for current estate tax liability.

7. A computer readable medium containing programming instructions for the financial and estate plan with liquidity analysis as claimed in claim 1 wherein said client assets classified in asset category IV include client assets which are exempt from creditors in bankruptcy and client assets which are tax inefficient funding products.

8. A computer readable medium containing programming instructions for the financial and estate plan with liquidity analysis as claimed in claim 1 wherein asset category IV encompasses client assets which represent tax deferred vehicles and includes annuities, qualified plans, IRA's, simplified employee pensions (SEP's) and life insurance within which are placed: corporate bonds, tax unqualified dividend securities such as real estate investment trusts, mutual funds that are tax inefficient by nature, and securities managed without tax consideration such as short term trading.

9. A computer readable medium containing programming instructions for the financial and estate plan with liquidity analysis as claimed in claim 1 including an asset category V which encompasses client assets which the client wishes to give while said client is alive either to heirs or charity wherein primary purposes of category V assets are reduction of future income and estate taxes, current enjoyment of heirs, charitable intent, and provide current estate liquidity.

10. A computer readable medium containing programming instructions for the financial and estate plan with liquidity analysis as claimed in claim 9 wherein life annual income values for each asset category I, II, III and IV are displayed next to a total life annual income values for category V assets.

11. A computer readable medium containing programming instructions for the financial and estate plan with liquidity analysis as claimed in claim 1 wherein the life annual income amount is overridden with a zero (-0-) for assets that will not produce income, or said life annual income is overridden with an amount input at the direction of said client for the life annual income obtained for the asset.

12. A computer readable medium containing programming instructions for the financial and estate plan with liquidity analysis as claimed in claim 1 wherein the protected life annual income amount is overridden with a zero (-0-) for assets that will not produce income, or said protected life annual income is overridden with an amount input at the direction of said client for the protected life annual income obtained for the asset.

13. A computer readable medium containing programming instructions for the financial and estate plan with liquidity analysis as claimed in claim 1 wherein any client asset is overridden with a zero (-0-) value or is overridden with an amount input at the direction of said client for said asset.

14. A computer readable medium containing programming instructions for the financial and estate plan with liquidity analysis as claimed in claim 1 wherein the post-death annual income amount is overridden with a zero (-0-) for assets that will not produce income, or said post-death annual income is overridden with an amount input at the direction of said client for the post-death annual income obtained for the asset.

15. A computer readable medium containing programming instructions for the financial and estate plan with liquidity analysis as claimed in claim 1 wherein the protected post-death annual income amount is overridden with a zero (-0-) for assets that will not produce income, or said protected post-death annual income is overridden with an amount input at the direction of said client for the protected post-death annual income obtained for the asset.

16. A computer readable medium containing programming instructions for the financial and estate plan with liquidity analysis as claimed in claim 1 including obtaining income related client financial data representing before tax earned income, after tax income, fixed living expenses and surplus after-tax earned income, said surplus after-tax earned income being calculated as the difference between said after tax income and said fixed living expenses, and displaying the income related client financial data upon command of the client.
